(19) United States
(12) Patent Application Publication
(10) Pub. No.: US 2012/0327584 A1
(43) Pub. Date: Dec. 27, 2012

(54) HARD DISK DEVICE

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/221,845

(22) Filed: Aug. 30, 2011

(30) Foreign Application Priority Data
Jun. 24, 2011 (CN) 201110172822.4

(51) Int. Cl. G06F 1/16

(52) U.S. Cl. 361/679.33

(57) ABSTRACT

A hard disk device includes a main portion and two pads. The main portion includes a front end, a rear end, a first side surface, a second side surface and a bottom surface. The first side surface defines a first connecting hole near the front end. The second side surface defines a second connecting hole near the front end. The bottom surface defines a first bottom connecting hole corresponding to the first connecting hole and a second bottom connecting hole corresponding to the second connecting hole. Each pad includes two connecting poles. A distal end of each connecting pole is toward the other connecting pole. The connecting poles of one of the pads are respectively insert into the first connecting hole and the first bottom connecting hole, and the connecting poles of the other pad are respectively insert into the second connecting hole and the second bottom connecting hole.

### CROSS-REFERENCE TO RELATED APPLICATION

This application is related to a commonly-assigned co-pending application entitled “HARD DISK DEVICE” (Attorney Docket No. US39064). The disclosure of the above-identified application is incorporated herein by reference.

### BACKGROUND

1. Technical Field

The present disclosure relates to storage devices, and particularly, relates to a hard disk device.

2. Description of Related Art

A hard disk device is a typical storage device for storing information therein. The hard disk device can be a built-in hard disk device or a portable hard disk device.

The hard disk device typically includes a main portion, a circuit board and other electronic elements mounted on the main portion, and a protective housing packaging the main portion therein for protecting the circuit board and other electronic elements. In assembly or during testing, the protective housing of the hard disk device may be removed from the main portion to expose the circuit board and other electronic elements. The hard disk device without the protective housing may be exposed to pollutants, such as dust and/or water on the table, causing short circuit to the hard disk device. In addition, the circuit board and other electronic elements may be damaged because of the direct contact to the table.

What is needed therefore is a hard disk device addressing the limitations described.

### BRIEF DESCRIPTION OF THE DRAWINGS

The components of the drawings are not necessarily drawn to scale, the emphasis instead being placed upon clearly illustrating the principles of the embodiments of the hard disk device. Moreover, in the drawings, like reference numerals designate corresponding parts throughout several views.

FIG. 1 is an exploded view of a hard disk device, according to an exemplary embodiment of the present disclosure.

FIG. 2 is similar to FIG. 1, but showing the hard disk from another angle.

FIG. 3 is an assembled view of the hard disk device of FIG. 1.

FIG. 4 is a schematic view of the hard disk device of FIG. 1 placed on a table.

### DETAILED DESCRIPTION

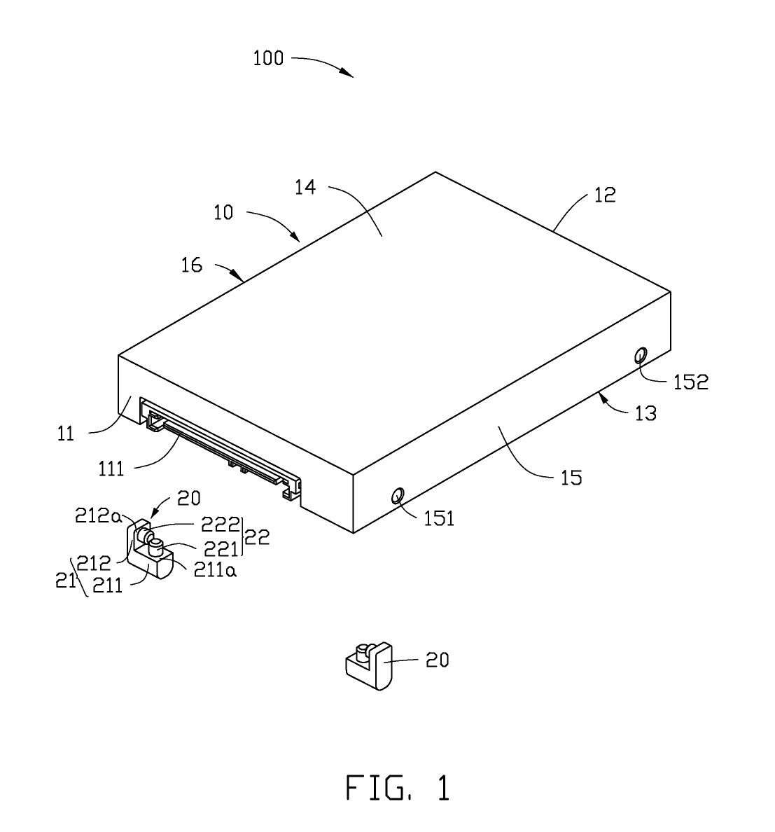

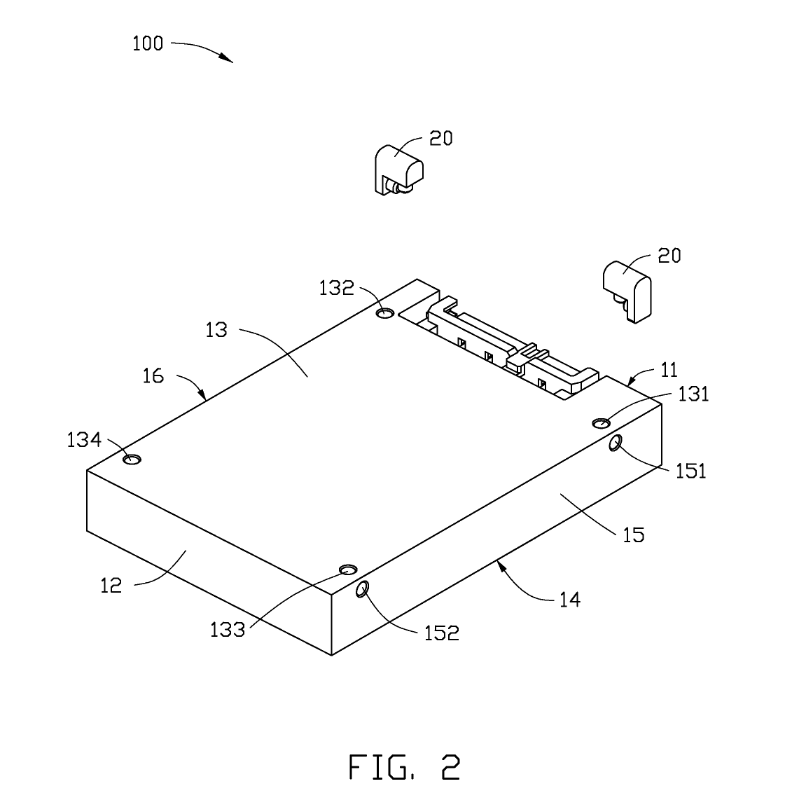

Referring to the FIGS. 1-2, a hard disk device 100, according to an exemplary embodiment, is shown. The hard disk device 100 includes a main portion 10 and a number of pads 20 connected to the main portion 10.

The main portion 10 is substantially cuboid-shaped. The main portion 10 includes a front end 11 and a rear end 12 opposite to the front end 11, a bottom surface 13, a top surface 14 opposite to the bottom surface 13, a first side surface 15, and a second side surface 16 opposite to the first side surface 15. The bottom surface 13, the top surface 14, the first side surface 15 and the second side surface 16 are between the front end 11 and the rear end 12. The front end 11 defines an inserting opening 111, for connecting the hard disk 100 to other devices (not shown). The bottom surface 13 is substantially parallel to the top surface 14, and the first side surface 15 is substantially parallel to the second side surface 16. The first side surface 15 defines a first connecting hole 151 near the front end 11. The second side surface 16 defines a second connecting hole 161 near the front end 11. In this embodiment, a central axis of the first connecting hole 151 is substantially aligned with that of the second connecting hole 161. The bottom surface 13 defines a first bottom connecting hole 131 near the first side surface 15 corresponding to the first connecting hole 151, and a second bottom connecting hole 132 near the second side surface 16 corresponding to the second connecting hole 161. A central axis of the first bottom connecting hole 131 is substantially perpendicular to that of the first connecting hole 151, and a central axis of the second bottom connecting hole 132 is substantially perpendicular to that of the second connecting hole 161. In this embodiment, the first connecting hole 151 communicates with the first bottom connecting hole 131, and the second connecting hole 161 is communicated with the second connecting hole 132. The main portion 10 includes a circuit board and other electronic elements (not shown) mounted thereon. At least a portion of the circuit board and other electronic elements are mounted on the bottom surface 13.

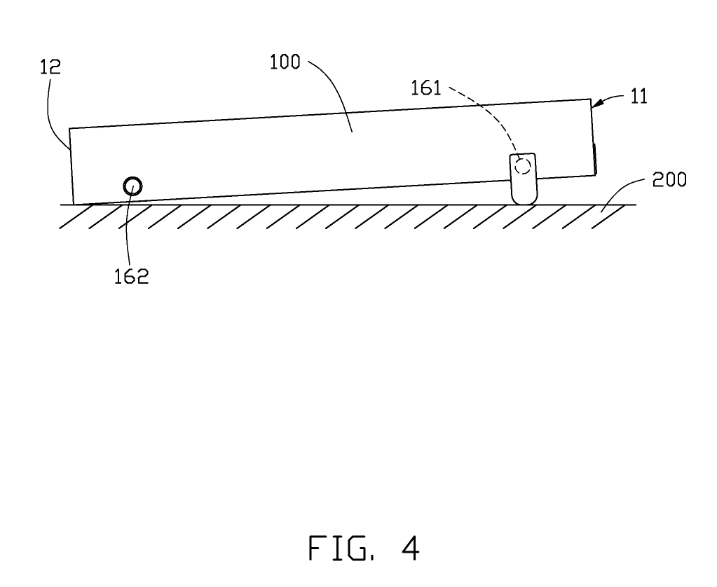

Furthermore, the first side surface 15 defines a third connecting hole 152 near the rear end 12, and the bottom surface 13 defines a third bottom connecting hole 133 near the first side surface 12 corresponding to the third connecting hole 152. The second side surface 16 defines a fourth connecting hole 162 (see in FIG. 4) near the rear end 12, and the bottom surface 13 defines a fourth bottom connecting hole 134 near the first side surface 12 corresponding to the fourth connecting hole 162. A central axis of the third connecting hole 152 is substantially perpendicular to that of the third bottom connecting hole 133, and a central of the fourth connecting hole 162 is substantially perpendicular to that of the fourth bottom connecting hole 134.

Each pad 20 includes an arm portion 21 and a connecting portion 22 connected to the arm portion 22. The arm portion 21 includes a first arm 211 and a second arm 212 connected to the first arm 211. The first arm 211 is substantially perpendicular to the second arm 212. The first arm 211 includes a first surface 211a, and the second arm 212 includes a second surface 212a. The connecting portion 22 includes two connecting poles 221, 222. In the exemplary embodiment, the first arm 211 and the second arm 212 are integrally formed with the connection portion 22. The connecting poles 221, 222 are respectively formed the first surface 211a and the second surface 212a. The pads 20 are made from elastic material, such as rubber or cork. In the exemplary embodiment, the number of the pads 20 is two.

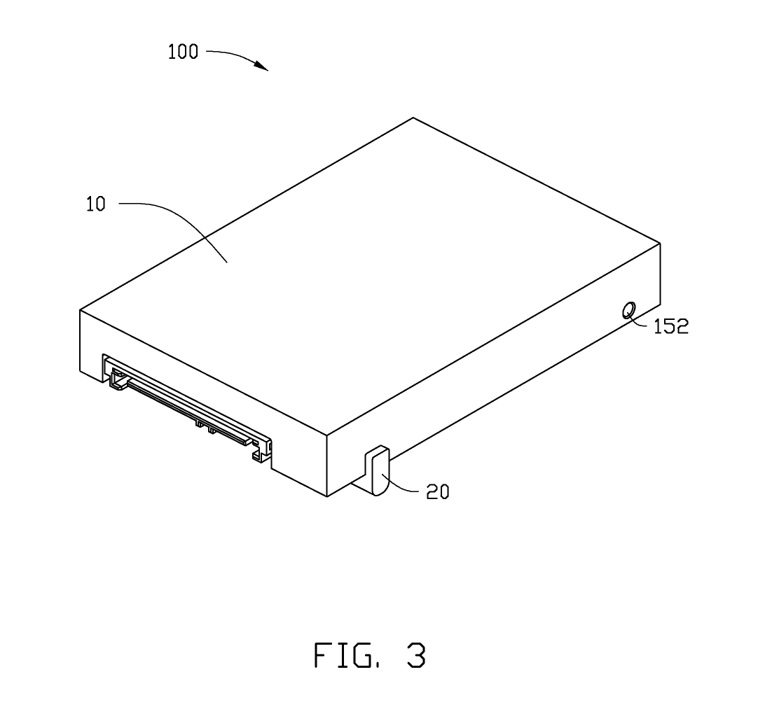

Referring also to FIG. 3, in assembly, the connecting poles 221, 222 of one pad 20 are respectively inserted into the first bottom connecting hole 131 and the first connecting hole 151, and the connecting poles 221, 222 of the other pad 20 are respectively inserted into the second bottom connecting hole 132 and the second connecting hole 161. Thus the first surface 211a is attached on the bottom surface 13, and the second surface 212a is attached on the first side surface 15 (or the second side surface 16).

Referring to FIG. 4, in assembly or testing, the hard disk device 100 can be put on a table 200, the bottom surface of the main portion 10 faces the table 200, the front end of the main portion 10 is spaced from the table 200 by the first arms 211 of the pads 20, and the circuit board and other electronic elements on the main portion 10 can also be spaced from the table 200. Thus, the circuit board and other electronic elements can avoid directly contacting to the table, and the pollution of the circuit board and other electronic elements caused by pollutants on the table 200 can also be avoided. Furthermore, because the front end 11 with the inserting opening 111 is spaced from the table 200 by the pads 20, so the hard disk 100 can conveniently connect the hard disk device 100 to other devices. In addition, the damage of the circuit board and other electronic elements caused by the table 200 can also be avoided. The pads 22 can absorb the shock of the table 200 because the elastic material thereof.

The hard disk device 100 can be received in a protective housing (not shown) after assembly or testing.

In other embodiments, the hard disk device 20 may include 4 pads configured the same as the pads 20, thus the third connecting hole 152 and the corresponding third bottom connecting hole 133 can be connected to one of the additional pads 20, and the fourth connecting hole 162 and the corresponding fourth bottom connecting hole 134 can be connected to the other of the additional pads 20.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A hard disk device, comprising:
a main portion, comprising:
a front end;
a rear end opposite to the front end;
a first side surface defining a first connecting hole near the front end;
a second side surface opposite to the first side surface defining a second connecting hole near the front end;
a top surface; and
a bottom surface opposite to the top surface defining a first bottom connecting hole near the first side surface and spatially corresponding to the first connecting hole and a second connecting hole near the second side surface and spatially corresponding to the second connecting hole; and
two pads, each of the pads comprising two connecting poles thereon, the connecting poles being substantially perpendicular to each other, a distal end of each of the connecting poles being toward the other of the connecting poles, the connecting poles of one of the pads being respectively inserted into the first connecting hole and the first bottom connecting hole, and the connecting poles of the other of the connecting poles being respectively inserted into the second connecting hole and the second bottom connecting hole, a portion of the pads contacting the bottom surface.

2. The hard disk device of claim 1, wherein the main portion defines an inserting opening in the front end thereof.

3. The hard disk device of claim 1, wherein a central axis of the first connecting hole is substantially aligned with that of the second connecting hole.

4. The hard disk device of claim 1, wherein a central axis of the first bottom connecting hole is substantially perpendicular to that of the first connecting hole, and a central axis of the second bottom connecting hole is substantially perpendicular to that of the second connecting hole.

5. The hard disk device of claim 1, wherein the first connecting hole is communicated with the first bottom connecting hole, and the second connecting hole is communicated with the second bottom connecting hole.

6. The hard disk device of claim 1, wherein each pad comprises an arm portion, the arm portion comprises a first arm and a second arm connected to the first arm, the first arm comprises a first surface contacting the bottom surface, the second arm comprises a second surface contacting a respective one of the first and second surfaces, the connecting poles are respectively connected to the first surface and the second surface.

7. The hard disk device of claim 1, wherein the pads are made from rubber or cork.

8. The hard disk device of claim 1, wherein the first side surface defines a third connecting hole near the rear end, the bottom surface defines a third bottom connecting hole near the first side surface and spatially corresponding to the third connecting hole, the second side surface defines a fourth connecting hole near the rear end, the bottom surface defines a fourth bottom connecting hole near the second side surface and spatially corresponding to the fourth connecting hole.

9. The hard disk device of claim 8, wherein the hard disk device comprises two additional pads configured the same as the pads, one of the additional pads is connected into the third connecting hole and the third bottom connecting hole, and the other of the additional pads is connected into the fourth connecting hole and the fourth bottom connecting hole.
